(19) United States
(12) Patent Application Publication
(10) Pub. No.: US 2015/0001127 A1
(43) Pub. Date: Jan. 1, 2015

(54) SUSTAINABLE PACKAGING TRAY AND PACKAGING SYSTEM AND METHOD OF MAKING SAME

(71) Applicant: Progressive Packaging Inc., Plymouth, MN (US)

(72) Inventors: Gregory Nelson, Plymouth, MN (US); Richard Steichen, Plymouth, MN (US)

(21) Appl. No.: 14/370,751

(22) PCT Filed: Jan. 4, 2013
(86) PCT No.: PCT/US13/20374

§ 371 Date: Jul. 3, 2014

Related U.S. Application Data
(60) Provisional application No. 61/583,560, filed on Jan. 5, 2012.

(51) Int. Cl. B65D 1/34; B29C 51/00; B29C 51/26; B29C 51/18; B65B 5/02; B65B 7/28

(52) U.S. Cl. CPC B65D 1/34; B65B 5/026; B65B 7/28; B29C 51/266; B29C 51/18; B29C 51/002; B29L 2031/712
USPC 206/557; 229/407; 53/456; 53/485; 264/161; 425/305.1

(57) ABSTRACT

A thermoformed tray made of material from the group consisting essentially of PET, RPET, HDPE, and RHDPE and a method of making the tray. The tray has a blunt and substantially smooth outer peripheral flange that will not cut a plastic overwrap film, such as LDPE. Referring now to the drawings, wherein like reference numerals designate identical or corresponding parts throughout the several views, FIG. 1 is a perspective view of one embodiment of a thermoformed packaging tray 10 preferably comprising PET, RPET, HDPE or RHDPE material. The techniques and processes for thermoforming a tray from PET, RPET, HDPE or RHDPE material are well known to those of ordinary skill in the art and therefore further discussion of the thermoforming process is not warranted.

### BACKGROUND

Meat processers and meat packers currently package fresh and frozen meat products predominantly in foamed or expanded polystyrene (EPS) trays which are then over-wrapped with a plastic wrap typically made from polyvinyl chloride (PVC) film. While polystyrene trays provide a low cost and versatile packaging solution, EPS has limited recyclability. EPS products are designated with a SPI (Society of the Plastics Industry) resin code “6” (more commonly referred to as a “recycling code”) which is not accepted by many recycling facilities. Additionally, food packaging made from EPS is being banned and legislated against in municipalities in California, Oregon and Washington.

While more acceptable recyclable materials such as polyethylene terephthalate (PET or PETE), having a SPI resin code “1”, or high density polyethylene (HDPE), having a SPI resin code “2”, could be used in place of EPS, trays made from PET or HDPE have higher material and manufacturing costs. While some companies are willing to incur slightly higher material and manufacturing costs in order to utilize a packaging system that is perceived by consumers as being more sustainable and environmentally friendly, the higher associated costs for the more environmentally friendly packaging must be commercially reasonable.

One significant drawback of using PET and HDPE for packaging trays is that the die cutting processes used in production of the trays creates outer peripheral flanges with sharp edges and burs which can easily cut through the plastic film used to overwrap the trays. While there are known processes for rolling the edges of circular PET and HDPE trays to eliminate the sharp flanges, heretofore, there has not been a process which can remove the sharp flanges and burs on rectangular shaped PET and HDPE packaging at high speed production levels. As such, there is a need for a process which is capable of producing blunt or smooth flanges on PET and HDPE trays at or near the same product levels achieved during the production of conventional PET and HDPE trays.

Another concern is the use of PVC film for overwrapping trays containing food products. Some countries have banned the use of PVC for food packaging applications due to studies showing that there is a risk of potentially harmful plasticizers in the PVC film migrating to certain food products such as cheeses, fatty fish and meat. A common alternative to PVC is low density polyethylene (LDPE) which does not contain harmful plasticizers. Accordingly, there is a need for a packaging system that utilizes LDPE in the overwrapping process of a tray made from PET, RPET, HDPE or RHDPE with a smooth flange to avoid cutting the LDPE overwrap during the overwrapping process and during shipment.

### DESCRIPTION OF THE DRAWINGS

FIG. 1 is a perspective view of one embodiment of a packaging tray made from PET, RPET, HDPE or RHDPE with a smooth flange produced in accordance with the method described herein.

FIG. 2 is a cross-sectional view of the packaging tray as viewed along lines 2-2 of FIG. 1.

FIG. 3 is a cross-sectional view of the packaging tray as viewed along lines 3-3 of FIG. 1.

FIG. 4 is an enlarged view of the edge of the tray shown in FIGS. 2 and 3.

FIG. 5 is a perspective view of an embodiment of a die assembly for making a smooth flange PET, RPET, HDPE or RHDPE tray.

FIG. 6 is a cross-sectional view of the die assembly as viewed along lines 6-6 of FIG. 5 and showing the thermoformed tray to be die cut positioned therein.

FIGS. 7-12 show the preferred steps for die-cutting and curling the edge of the thermoformed tray to form a smooth flange.

FIG. 7A is an enlarged detail view of the circled portion of FIG. 7.

FIG. 7B is an enlarged detail view of the edge of the thermoformed tray after being die-cut but prior to curling.

FIG. 8A is an enlarged detail view of the circled portion of FIG. 8.

FIG. 9A is an enlarged detail view of the circled portion of FIG. 9.

FIG. 10A is an enlarged detail view of the circled portion of FIG. 10.

FIG. 11A is an enlarged detail view of the circled portion of FIG. 11.

FIG. 12A is an enlarged detail view of the circled portion of the tray of FIG. 12 showing an embodiment of the smooth flange created after performing the steps illustrated in FIGS. 7-11.

FIG. 12B is the same as FIG. 7B but is illustrated in relation to the smooth flange embodiment of FIG. 12A to better illustrate the change in the flange before curling (FIG. 12B) and after curling (FIG. 12A).

FIG. 13 illustrates adjacent, stacked overwrapped trays with the smooth flange produced after performing the steps illustrated in FIGS. 7-11.

FIG. 13A is an enlarged detail view showing abutting edges of overwrapped trays with the smooth flange to illustrate that the smooth flanges will not cut the plastic overwrap of the adjacent tray during packaging and shipping.

### DESCRIPTION

Referring now to the drawings, wherein like reference numerals designate identical or corresponding parts throughout the several views, FIG. 1 is a perspective view of one embodiment of a thermoformed packaging tray 10 preferably comprising PET, RPET, HDPE or RHDPE material. The techniques and processes for thermoforming a tray from PET, RPET, HDPE or RHDPE material are well known to those of ordinary skill in the art and therefore further discussion of the thermoforming process is not warranted.

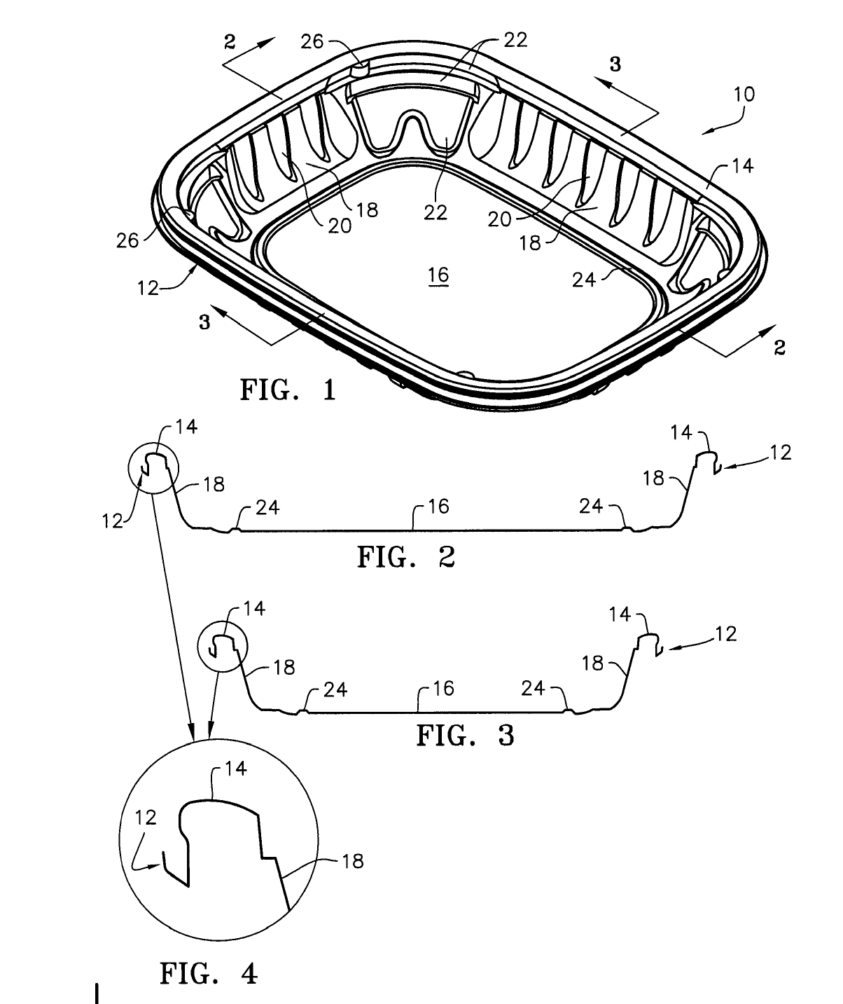

The tray 10, in its final form after the curling process is performed as hereinafter described, has a smooth outer peripheral flange 12. FIGS. 2 and 3 are cross-sectional views of the packaging tray 10 as viewed along lines 2-2 and 3-3, respectively of FIG. 1. FIG. 4 is an enlarged view of an embodiment of the smooth outer peripheral flange 12. The packaging tray 10 as illustrated in FIGS. 1-3, is generally rectangular in shape having a top edge 14, a bottom surface 16 and sidewalls 18. Although the tray 10 is illustrated as being of a size suitable for a one pound hamburger meat tray, for example, it should be appreciated that the tray 10 may be any desirable size, shape or configuration.

The sidewalls 18 are shown as having various shaped ribs 20 and corner details 22 as well as a bottom peripheral rib 24. The tray 10 also preferably includes de-nesting ribs 26 placed to assist easier separation of the empty stacked trays during the packaging process, which is typically automated. Those of skill in the art will appreciate that incorporating ribs and corner details as well as the size and configuration of such details are designed to provide rigidity to the bottom and sidewalls of the tray in order to withstand the loads and stresses applied during the overwrapping and other packaging process as well as during stacking and shipping of the trays. Thus, the size and configuration of such details may vary depending on the size and configuration of the tray and depending on the rigidity needed to withstand the loads and stresses to which the trays may be subject.

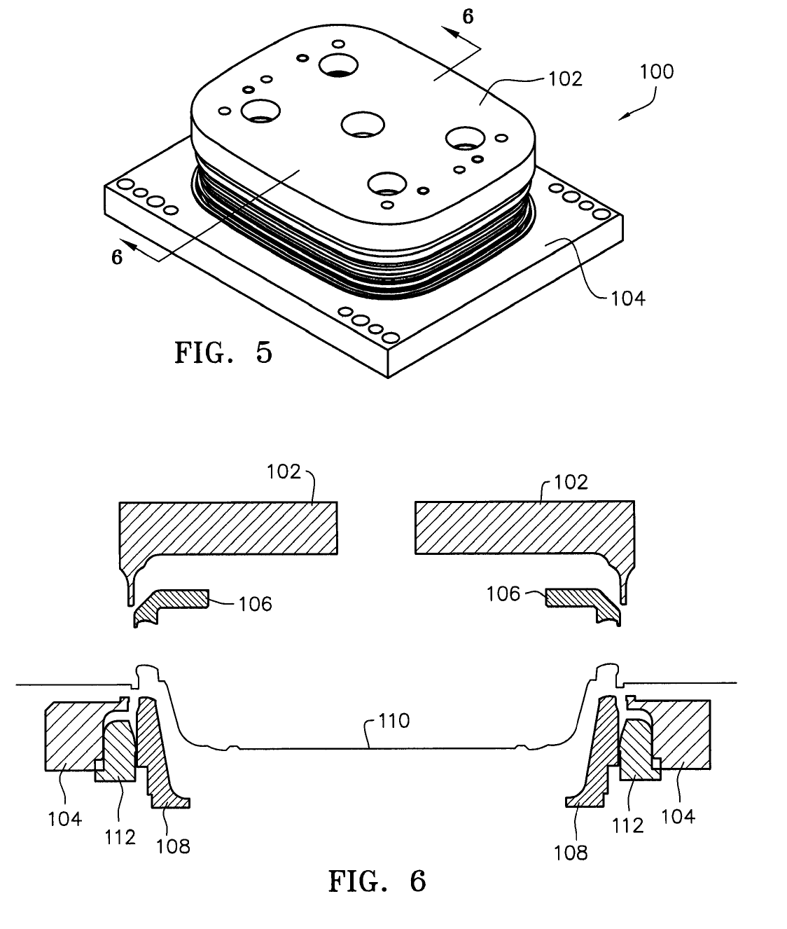

FIG. 5 is a perspective view of an embodiment of a die assembly 100 for making the tray 10. FIG. 6 is a cross-sectional view of the die assembly 100 as viewed along lines 6-6 of FIG. 5 and showing the thermoformed tray part 110 positioned therein. The die assembly 100 comprises a punch 102, which, as discussed later, cooperates with the die block 104 to shear off the excess thermoformed material 111 surrounding the formed tray part 110. The formed tray part 110 is produced using a separate thermoforming machine (not shown) as well known to those skilled in the thermoforming art. The die assembly 100 further comprises a driver plate 106 that cooperates with the support ring 108 and the curl plate 112 to form the smooth outer peripheral flange 12 as discussed in detail later.

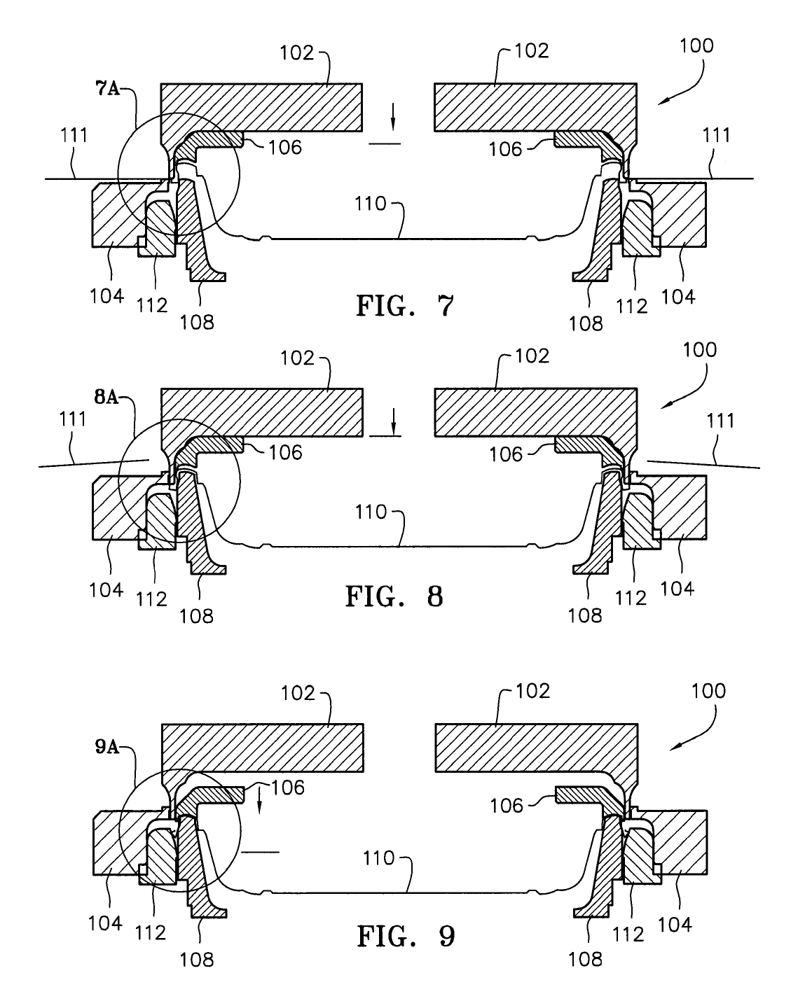

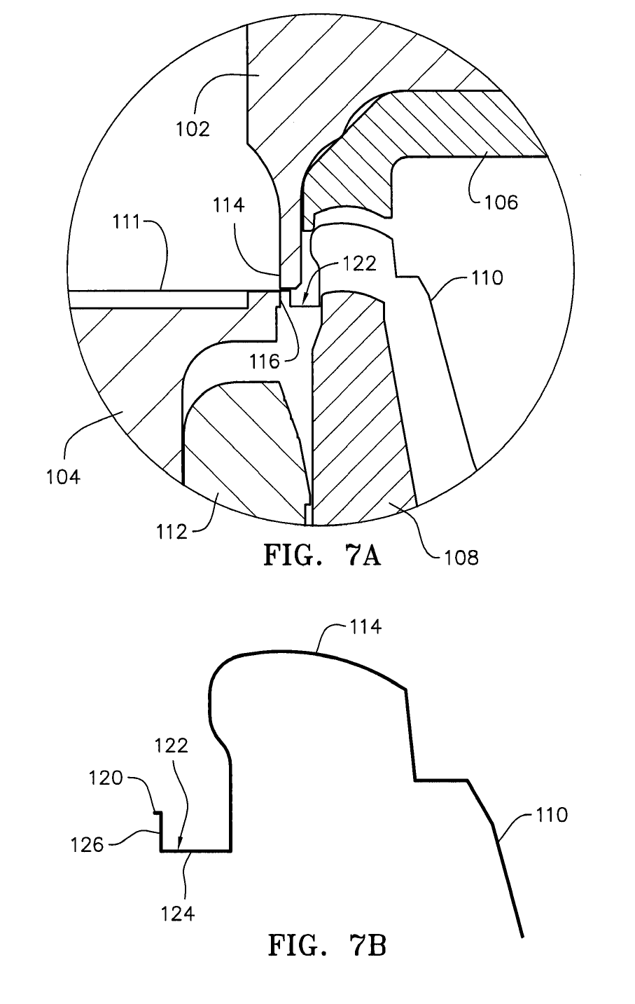

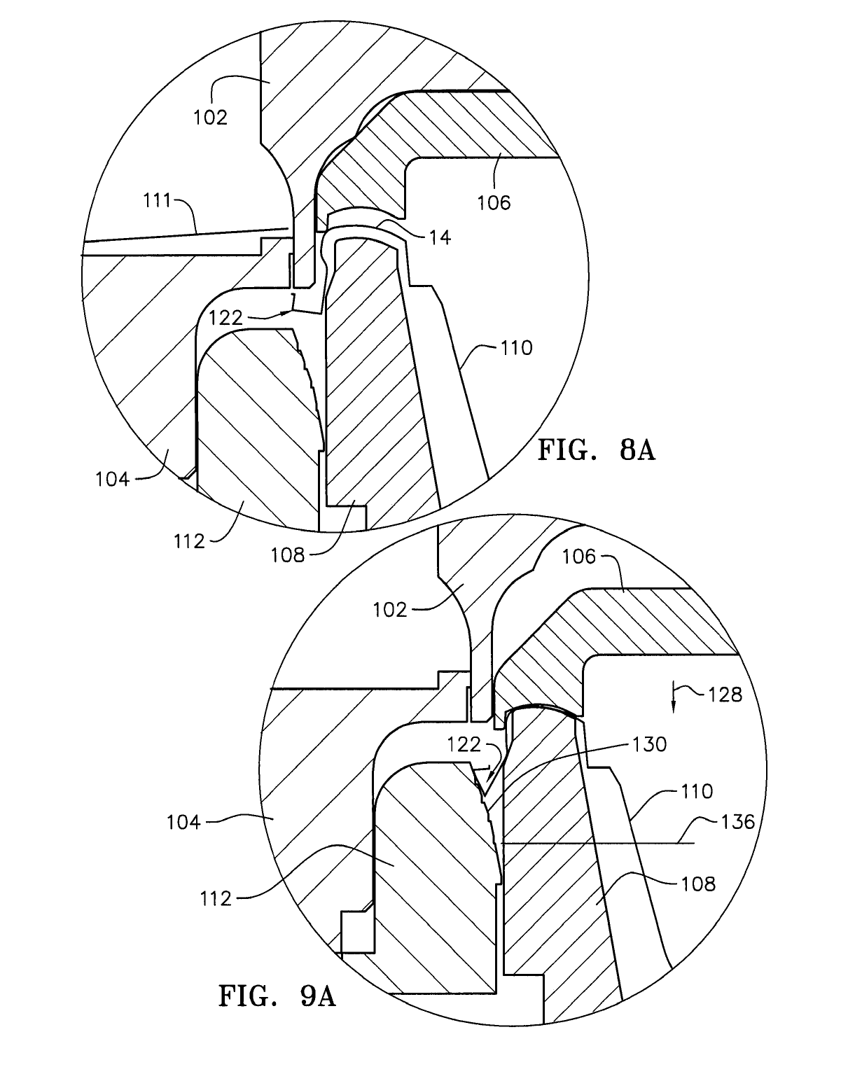

FIGS. 6-12 show the preferred steps for die-cutting and curling the edge of the thermoformed material to form the smooth outer peripheral flange 12. Beginning with FIG. 6, the die assembly 100 is shown in the open position and showing the thermoformed tray part 110. With the thermoformed tray part 110 properly positioned in the die assembly 100, the punch 102 is actuated, as shown in FIG. 7-8, causing the punch 102 to move toward the die block 104 to shear off the excess material 111. As illustrated in FIGS. 7A, 7B and 8A, as the punch edge 114 (FIG. 7A) passes the die block edge 116 (FIG. 7A), the excess material 111 is sheared off, leaving only a small lip 120 (FIG. 7B) extending outwardly from the flange 122 formed around the perimeter of the tray part 110. Referring to FIG. 7B, the flange 122 is preferably formed into a U-shape with a horizontal leg 124 and an upwardly extending vertical leg 126. The U-shaped configuration has been found to produce a more uniform smooth flange 12 from the curling process described later. However, it should be appreciated that any configuration may be used for the flange 122, that results in a substantially uniform smooth flange after performing the curling process.

The punch 102 continues to advance until it abuts a stop (not shown) which prevents the punch from over penetrating the die block. After the excess material 111 is sheared off, the curling process is initiated. As shown in FIG. 9-11, the driver plate 106 is actuated to drive the flange 122 of the tray part 110 between the curl plate 112 and the support ring 108, preferably in one fluid motion. As best illustrated in FIG. 9A, the driver plate 106 advances toward the support ring 108 pinching the top edge 14 of the tray part 110 between them as the driver plate 106 continues to advance downwardly as indicated by the arrow 128 toward line 136. As the driver plate 106 advances, the flange 122 comes into contact with the wedge shaped face 130 of the curl plate 112, causing the horizontal leg 124 of the flange 122 to start to bend upwardly. Teeth or serrations 132 are preferably formed in the wedge shaped face 130 of the curl plate 112. These serrations 132 serve as friction points or grab points. As the flange 122 comes in contact with the serrations 132, each serration will grab and release the flange 122, each time, curling the flange 122 upward, a step at a time, producing a more controlled and consistent curl of the flange. Without the serrations 132 it was found that the resulting “curl” of the flange around the perimeter of the tray is inconsistent, with a longer curled flange at the corners of the tray than along the sides. Nevertheless, there may be suitable means other than the use of serrations to produce a consistent curl of the flange

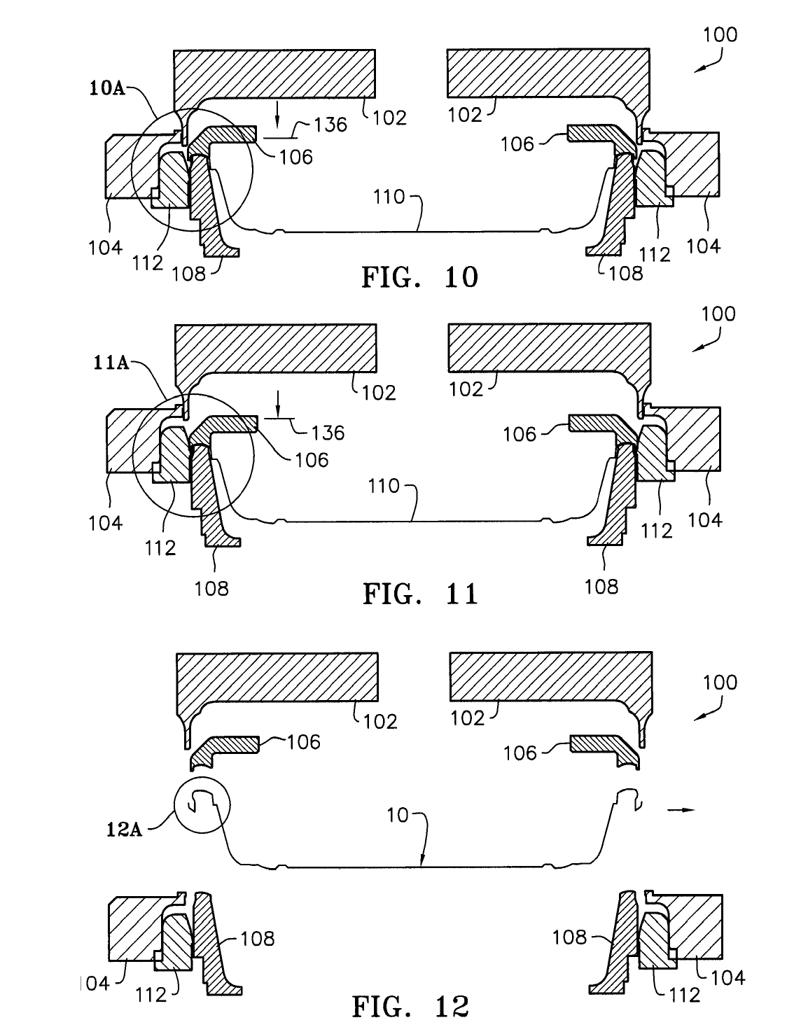

Referring to FIGS. 10A-11A, the continued advancement of the driver plate 106 toward the curl plate 112, forces the horizontal and vertical legs 124, 126 and the lip 120 of the flange 122 to further collapse and curl until the flange 122 is compressed between the wedge shaped face 130 of the curl plate 112 and the outer face 134 of the support ring 108 resulting in the lip 120 and legs 124, 126 of the flange 122 being sufficiently strained to achieve plastic deformation such that the original die-cut configuration of the flange 122 is not recoverable after release of the stress. It should be appreciated that the tolerances creating the gap between the curl plate 112 and the support ring 108 into which the flange 122 is forced to create the plastic deformation may depend on the thickness of the thermoformed material 110, the type of material and the configuration of the flange.

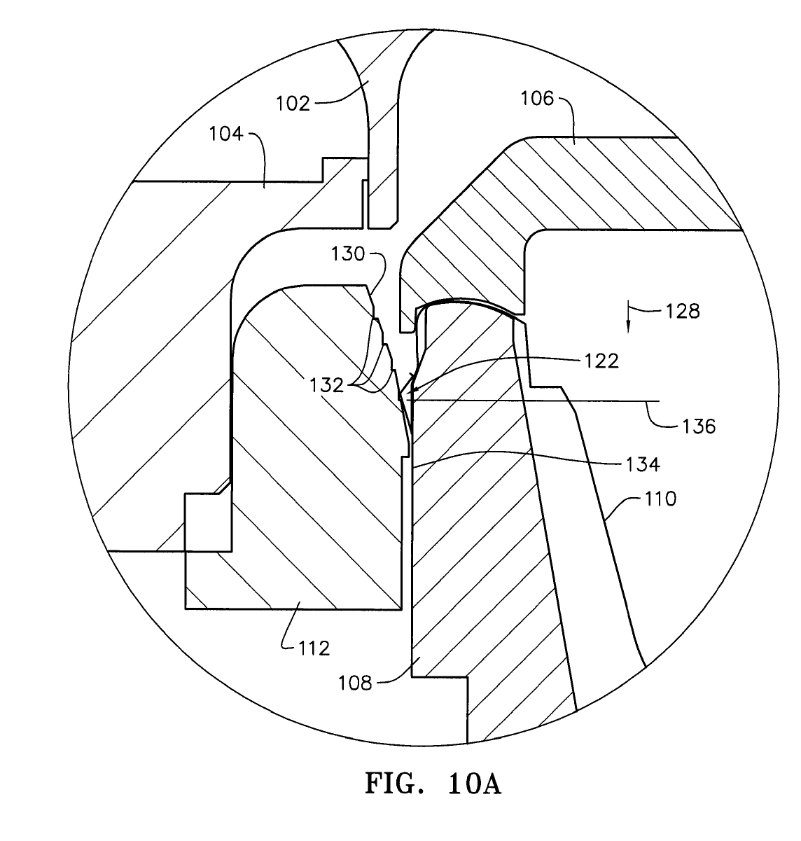

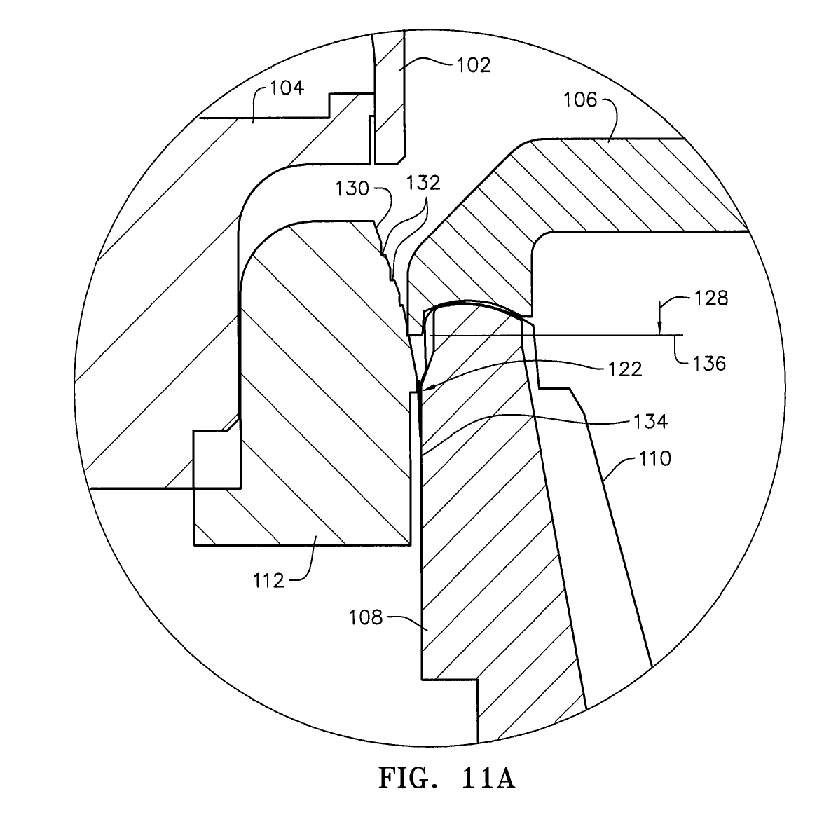

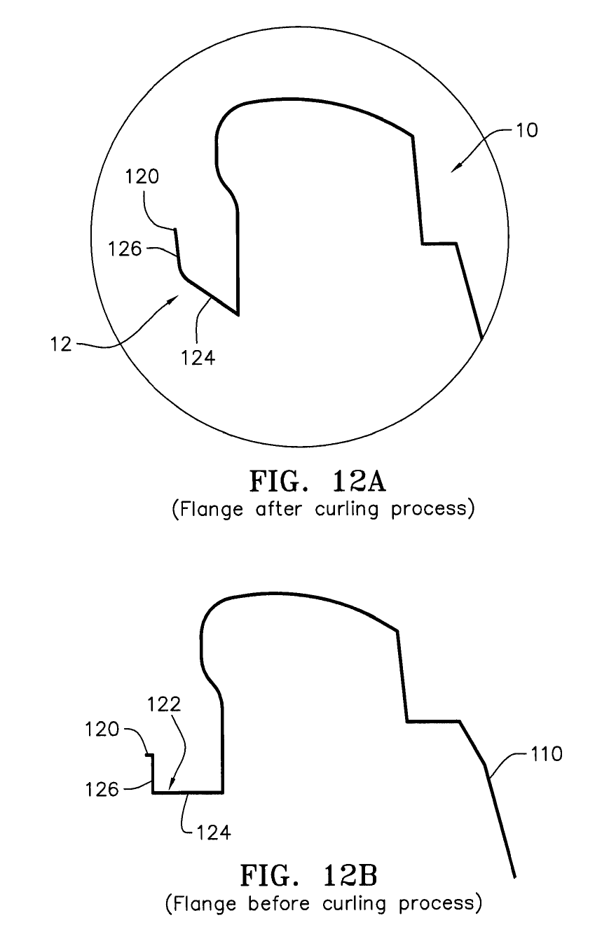

Referring to FIG. 12, once the driver plate 106 reaches the stop point as indicated by the line 136, its motion is reversed, and it, along with the punch 102, returns to the original starting position. With the release of the force exerted by the driver plate 106, the support ring 108, which is preferably spring loaded or biased, also returns to its starting position. The formed tray 10 is then removed from the die assembly 100. The formed tray 10 may be removed manually or through any automated process well know to those of skill in the art.

FIG. 12A, is an enlarged detail view of the circled portion of the finished tray 10 of FIG. 12 showing an embodiment of the flange created after performing the steps illustrated in FIGS. 6-11. It should be appreciated that because the flange 122 was plastically deformed, the lip 120 and vertical leg 126 now substantially smoothly transition to what was formerly the horizontal leg 124 of the U-shaped flange. Compare FIG. 12B showing the flange 122 prior to being curled to FIG. 12A. As previously stated, although a U-shaped flange has been shown to produce the desirable flange 12, any suitable flange shape may be formed into the thermoformed material 110 that results in a blunt peripheral flange 12 after performing the curling process so as not to leave any burs or sharp edges that can cut or pierce the plastic wrap that may be used to overwrap the tray as discussed below.

It should be appreciated that the foregoing process of die-cutting and curling the peripheral flange to eliminate the sharp edges and burs typical of the flanges of conventional die cut PET and HDPE trays is achieved in a single process and at speeds that are at or near the same production speeds achieved during the production of conventional die cut PET and HDPE trays that result in sharp edges and burs.

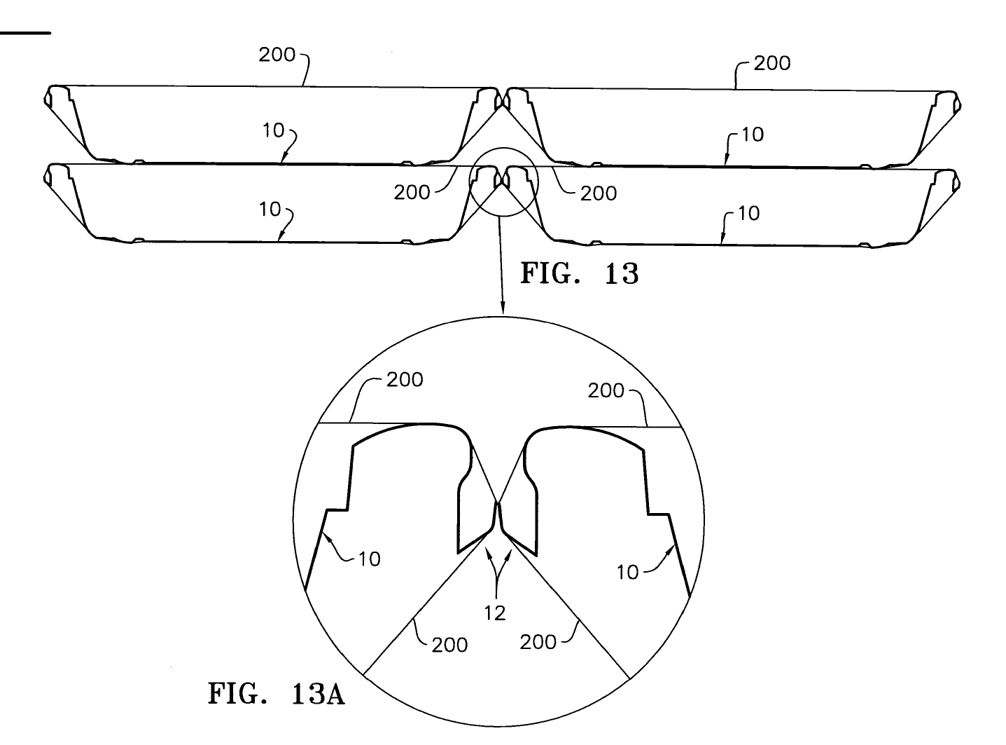

FIG. 13 shows a plurality of packaging trays 10 over-wrapped with a plastic wrap 200 and stacked vertically and horizontally with respect to one-another. The plastic wrap 200 may be PVC, LDPE or other suitable film material. FIG. 13A is an enlarged detail view illustrating how the blunt edges or smooth flanges 12 of adjacent trays abut one another and are capable of flexing so as not to cut the plastic overwrap of the adjacent tray during packaging and shipping.

While the foregoing embodiment of the tray 10 is described as having its primary application for packaging that utilizes overwrapped film, the tray 10 having a smooth outer peripheral flange 12 is also particularly well suited for medical applications in which medical products are sealed within the tray with a peel-off covers. It is known that PET and HDPE trays used in such medical applications often have sharp edges and burs that can cut through the gloves of the medical personnel handling the packages. Accordingly it would be beneficial to utilize the foregoing curling process to produce a medical tray package that has blunt edges or substantially smooth outer peripheral flanges that will not cut or pierce medical gloves during handling.

The foregoing description is presented to enable one of ordinary skill in the art to make and use the invention and is provided in the context of a patent application and its requirements. Various modifications to the preferred embodiment of the apparatus, and the general principles and features of the system and methods described herein will be readily apparent to those of skill in the art. Thus, the present invention is not to be limited to the embodiments of the apparatus, system and methods described above and illustrated in the drawing figures, but is to be accorded the widest scope consistent with the spirit and scope of the appended claims.

1. A packaging tray comprising:
a tray made of material from the group consisting essentially of PET, RPET, HDPE, and RHDPE, said tray having a top edge, a bottom surface and sidewalls defining an interior volume, said tray further having a blunt and substantially smooth peripheral flange that will not cut an overwrap film.

2. The packaging tray of claim 1 wherein said tray is rectangular.

3. The packaging tray of claim 1 overwrapped with plastic wrap.

4. The packaging tray of claim 3 wherein said overwrap is LDPE.

5. A method of forming a tray having a blunt and substantially smooth peripheral flange that will not cut an overwrap film; said method comprising:
thermoforming a tray with a formed peripheral flange;
die-cutting said tray to remove excess material resulting from said thermoforming process from around said formed peripheral flange;
plastically deforming said formed peripheral flange by a compressive force, whereby upon removal of said compressive force said plastically deformed peripheral flange is blunt and substantially smooth such that will not cut an overwrap film.

6. The method of claim 5 wherein said step of plastically deforming said formed peripheral flange includes, compressing said formed peripheral flange between a first face of a first plate and a second face of a second plate.

7. The method of claim 6 wherein said first face of said first plate is wedge shaped.

8. The method of claim 7 wherein said wedge shaped face is stepped.

9. The method of claim 5 wherein said tray is rectangular.

10. The method of claim 5 wherein said tray is made of material from the group consisting essentially of PET, RPET, HDPE, and RHDPE.

11. The method of claim 9 wherein said tray is made of material from the group consisting essentially of PET, RPET, HDPE, and RHDPE.

12. The method of claim 5 wherein said formed peripheral flange is U-shaped, having an inner substantially vertical leg, an outwardly extending substantially horizontal leg, and an outer substantially vertical leg, and wherein said outer substantially vertical leg has a substantially horizontal outwardly projecting lip resulting from said die-cutting step, and wherein said step of plastically deforming said U-shaped flange results in said substantially horizontal leg, said outer substantially vertical leg and said substantially horizontal outwardly projecting lip forming said blunt and substantially smooth peripheral flange which transitions from said inner substantially vertical leg.

13. A die assembly for forming a blunt and substantially smooth peripheral flange of a thermoformed tray that will not cut an overwrap film, said die assembly comprising:
a die block adapted to receive a thermoformed tray part with a tray formed therein said tray having a formed peripheral flange;
a punch which cooperates with said die block so as to shear excess thermoformed material from around said formed peripheral flange;
a curl plate;
a support ring adapted to support a top edge of said tray;
a driver plate adapted to cooperate with said support ring so as to hold said top edge of said tray therebetween and to drive said formed peripheral flange toward said curl plate, whereby as said drive plate advances toward said curl plate, said formed peripheral flange is compressed between a face of said curl plate and a face of said support ring, said faces of said curl plate and said support ring being sufficiently close to cause said formed peripheral flange to plastically deform when compressed between said faces, resulting in said plastically deformed peripheral flange being blunt and substantially smooth.

14. The die assembly of claim 16 wherein said face of said curl plate is wedge shaped.

15. The die assembly of claim 14 wherein said wedge shaped face is stepped.

16. The die assembly of claim 16 wherein said tray is rectangular.

17. The die assembly of claim 5 wherein said thermoformed sheet is made of material from the group consisting essentially of PET, RPET, HDPE, and RHDPE.

18. A method of producing a thermoformed tray with a plastic film overwrap, the thermoformed tray having a blunt and substantially smooth peripheral flange that will not cut the overwrap film, said method comprising:
placing a thermoformed tray part with a tray formed therein into a die block, said tray having a formed peripheral flange;
shearing excess thermoformed material from around said formed peripheral flange;
support a top edge of said tray by a support ring;
holding said top edge of said tray between said support ring and a driver plate;
driving said driver plate and said support ring with said top edge of said tray therebetween toward a curl plate, whereby as said drive plate advances toward said curl plate, said formed peripheral flange of said tray is compressed between a face of said curl plate and a face of said support ring, said faces of said curl plate and said support ring being sufficiently close to cause said formed peripheral flange to plastically deform when compressed between said faces;
removing said tray from said die block, said tray having a blunt and substantially smooth peripheral flange;
overwrapping said tray with a plastic film.

19. The method of claim 18 wherein a face of said curl plate is wedge shaped.

20. The method of claim 19 wherein said wedge shaped face is stepped.

21. The method of claim 18 wherein said tray is rectangular.

22. The method of claim 18 wherein said tray is made of material from the group consisting essentially of PET, RPET, HDPE, and RHDPE.

23. The method of claim 21 wherein said tray is made of material from the group consisting essentially of PET, RPET, HDPE, and RHDPE.

24. The method of claim 18 wherein said plastic film is LDPE.

25. The method of claim 18 wherein said formed peripheral flange is U-shaped, having an inner substantially vertical leg, an outwardly extending substantially horizontal leg, and an outer substantially vertical leg, and wherein said outer substantially vertical leg has a substantially horizontal outwardly projecting lip resulting from said shearing step, and wherein said plastic deformation of said U-shaped peripheral flange results in said substantially horizontal leg, said outer substantially vertical leg and said substantially horizontal outwardly projecting lip forming said blunt and substantially smooth peripheral flange which transitions from said inner substantially vertical leg.
